(19) United States
(12) Patent Application Publication
(10) Pub. No.: US 2005/0050646 A1
(43) Pub. Date: Mar. 10, 2005

(54) METHOD FOR SENSING AMOUNT OF LAUNDRY OF WASHING MACHINE

(76) Inventors: Tae Hee Lee, Seoul (KR); Byung Keol Choi, Kyungki-do (KR); Hyun Seok Seo, Inchun-si (KR); Sang Wook Hong, Seoul (KR); Moon Hee Hong, Seoul (KR); Si Moon Jeon, Seoul (KR)

Correspondence Address: BIRCH STEWART KOLASCH & BIRCH, PO BOX 747, FALLS CHURCH, VA, 22040-0747, US

(21) Appl. No.: 10/853,155

(22) Filed: May 26, 2004

(30) Foreign Application Priority Data
Sep. 4, 2003 (KR) 10-2003-0061746

(51) Int. Cl. B08B 3/12

(52) U.S. Cl. 8/158; 68/3 R

(57) ABSTRACT

Disclosed is a method for precisely sensing an amount of laundry of a washing machine without influence of static friction. The method includes the steps of (a) operating a motor, and then carrying out regenerative braking of the motor, (b) re-operating the motor after the step (a), and then carrying out rheostatic braking of the motor, and (c) determining the amount of laundry by means of the principle of the conservation of energy in the regenerative braking of the motor in the step (a) and the principle of the conservation of energy in the rheostatic braking of the motor in the step (b).

### BACKGROUND OF THE INVENTION

1. Field of the Invention

The present invention relates to a method for sensing an amount of laundry of a washing machine, and more particularly to a method for sensing an amount of laundry of a washing machine by means of regenerative braking and rheostatic braking of a motor.

2. Description of the Related Art

Generally, washing machines are apparatuses for removing contaminants from laundry by the action of detergent and water. Recent washing machines sense an amount of the laundry therein, and thus determine a washing water level, a washing time, an amount of the detergent, a rinsing or washing water current, thereby allowing the laundry to be washed, rinsed, dehydrated and dried.

FIG. 1 is a longitudinal-sectional view of a conventional washing machine.

As shown in FIG. 1, the conventional washing machine comprises a casing 2 forming an external appearance of the washing machine, a tub 10 arranged in the casing 2 for containing washing water (w), a drum 20 rotatably arranged in the tub 10 for accommodating laundry (m), and a motor 30 for supporting and rotating the drum 20.

An entrance hole 2a is formed through one surface of the casing 2 for placing the laundry (m) into the casing 2 therethrough, and a door 4 for opening and closing the entrance hole 2a is installed on the surface of the casing 2.

The door 4 includes a door frame 5 rotatably connected to the casing 2, and a door glass 6 installed on the door frame 5.

An opening 21 is formed through the drum 20 for placing the laundry (m) into the drum 20 therethrough, and a plurality of water pores 22 are formed through the drum 20 for allowing the washing water (w) to pass through the drum 20.

A rotary shaft 32 of the motor 30 penetrates the tub 10 and is supported to the tub 10 by a bearing 34, and a front end of the rotary shaft 32 is connected to the drum 20.

The washing machine further comprises a water supply device for supplying the washing water (w) from the outside into the tub 10. The water supply device includes a water supply valve 42 connected to an external hose 41 for intermitting clean water supplied through the external hose 41, and a detergent box 43 having a detergent storing chamber, a water supply passage and an outlet for causing the water supplied into the washing machine to be mixed with detergent stored by the detergent storing chamber and then to be discharged therefrom.

The washing machine further comprises a drainage device for discharging the washing water (w) in the tub 10 to the outside. The drainage device includes a drainage bellows tube 45 for guiding the washing water (w) in the tub 10, and a drainage pump 46 (or a drainage valve) for pumping (or intermitting) the washing water (w), which is discharged.

The washing machine further comprises a control unit 49 for controlling the motor 30, the water supply valve 42 and the drainage pump 46 according to a user's manipulation or a sensed amount of the laundry (m).

The control unit 49 includes a braking device for carrying out regenerative braking of the motor 30 or consuming generated electricity of the motor 30 when the motor 30 is switched off.

FIG. 2 is a block diagram of a braking device of the conventional washing machine.

As shown in FIG. 2, a conventional braking device 50 includes a rectifying unit 51 for converting a utility AC power source into a DC voltage and outputting the converted DC voltage, a smoothing unit 52 for smoothing the DC voltage, which was rectified by the rectifying unit 51, a motor-driving unit 52 for driving the motor 30 by means of the DC voltage, which was transferred by the rectifying unit 51, a voltage-sensing unit 54 for sensing a voltage flowing in the washing machine when the motor 30 is suddenly stopped, and outputting a sensed voltage generated due to the sensed result, a voltage-comparing unit 55 for comparing the sensed voltage of the voltage-sensing unit 54 to a standard voltage stored in advance in the washing machine, a switching unit 56 for determining whether or not a damping resistance (R) is switched on/off based on the compared result, a sensor 57 for sensing an operating state of the motor 30, such as a rotary position and a speed of the motor 30, and a microcomputer 58 for controlling the motor 30 based on the operating state of the motor 30 sensed by the sensor 57, and controlling the output of overvoltage of the washing machine when the motor 30 is braked, and a signal-outputting unit 59 for generating a control signal based on the controlled result of the microcomputer 58, and outputting the generated control signal to the motor-driving unit 52.

The braking device 50 serves to convert the inertia of the motor 30 and the laundry into electrical energy, to carry out the regeneration of the motor-driving unit 53, and then to accumulate the regenerated energy in the smoothing unit 52.

In case that the DC voltage accumulated in the smoothing unit 52 is higher than the standard voltage, which was stored in advance in the washing machine, the microcomputer 58 switches on the switching unit 56, and switches on the damping resistance (R). Then, the damping resistance (R) dissipates the DC voltage accumulated by the smoothing unit 52 in the form of heat, thereby protecting the smoothing unit 52.

In case that the DC voltage accumulated in the smoothing unit 52 is lower than the standard voltage, which was stored in advance in the washing machine, the microcomputer 58 switches off the switching unit 56, and switches off the damping resistance (R). Then, the DC voltage regenerated by the motor-driving unit 53 is accumulated in the smoothing unit 52.

In case that the damping resistance (R) is switched on regardless of the voltage sensed by the voltage-sensing unit 54 when the motor 30 is switched off, the braking device 50 does not carry out the regeneration of electricity, but dissipates the electricity in the form of heat. In case that the damping resistance (R) is switched off regardless of the voltage sensed by the voltage-sensing unit 54, the damping resistance (R) allows the generated electricity to flow into the smoothing unit 52 and to be accumulated in the smoothing unit 52.

Hereinafter, operation of the above-described conventional washing machine will be described in detail.

First, the laundry (m) is put into the drum 20, and the door 4 is closed. Thereafter, the washing machine is operated. The control unit 49 switches the motor 30 on/off, and senses an amount of the laundry (m). Then, the control unit 49 determines a washing water level, a washing time, an amount of detergent, a rinsing or washing water current based on the sensed amount of the laundry (m), thereby allowing the washing machine to be sequentially operated in wash, rinse, dehydration and dry modes.

That is, the control unit 49 controls the water supply valve 42 for a designated time based on the sensed amount of the laundry (m), and then supplies washing water into the washing machine so that the washing water reaches a designated water level. The washing water is supplied into the tub 10. Thereafter, the control unit 49 operates the motor 30 at a designated rotational frequency for a designated time, thereby rotating the drum 20. The laundry (m) contained in the drum 20 is cleaned by the action of the washing water (w). After the above-described wash mode of the washing machine is finished, contaminated washing water in the tub 10 is discharged to the outside through the drainage device.

Thereafter, the rinse mode for rinsing soap bubbles out of the laundry (m) is carried out several times. In the rinse mode in the same manner of the wash mode, the control unit 49 controls the water supply valve 42 and the motor 30 so as to rinse the soap bubbles out of the laundry (m), and the contaminated washing water containing the soap bubbles is discharged to the outside through the drainage device 12.

After the rinse mode is repeated several times, the washing machine is operated in the dehydration mode, in which the motor 30 is operated at a high speed for centrifugally dehydrating the laundry (m).

FIG. 3 is a flow chart illustrating a method for sensing an amount of laundry of the conventional washing machine. FIG. 4 is a graph illustrating operation of a motor for sensing the amount of laundry of the conventional washing machine.

Hereinafter, the method for sensing the amount of the laundry of the conventional washing machine will be described in detail with reference to FIGS. 3 and 4.

The motor 30 is operated (S1), and is accelerated until a rotational frequency (rpm) of the motor 30 reaches a standard rotational frequency (rpm′) set in advance (S2). When the rotational frequency (rpm) of the motor 30 reaches the standard rotational frequency (rpm′), the motor is maintained at a constant speed for a designated time (T_{S}) (S3), and then the motor 30 is switched off (S4).

Then, a value of PWM (Pulse Width Modulation) duty from the starting of the operation of the motor 30 to the maintaining of the operation of the motor 30 at the constant speed is measured (S5).

An angle of rotation of the motor 30 generated by excess rotation of the motor 30 is measured (S6).

Thereafter, a numerical value, which is obtained by multiplying the average of the measured value of the PWM duty by a proportional constant (a), is added to a numerical value, which is obtained by multiplying the angle of rotation of the motor 30, generated by excess rotation of the motor 30, by a proportional constant (b), thereby finally producing a value for determining an amount of the laundry (S7).

Since the conventional washing machines have different degrees of friction generated when the drum 20 is rotated (for example, friction between the drum 20 and the bearing 34, friction between the door glass 6 and the laundry (m), etc.), the method for sensing the amount of the laundry of the conventional washing machines has a problem in that the conventional washing machines have different values for determining the amount of the laundry due to the difference of the frictions.

Further, since the determined amount of the laundry is proportional to the average of the measured value of the PWM duty from the starting of the operation of the motor 30 to the maintaining of the operation of the motor 30 at a constant speed, the method for sensing the amount of the laundry of the conventional washing machines has a problem in that static friction generated, when the operation of the motor 30 is started, affects the sensing of the amount of the laundry, and thus it is difficult to precisely sense the amount of the laundry.

### SUMMARY OF THE INVENTION

Therefore, the present invention has been made in view of the above problems, and it is an object of the present invention to provide a method for sensing an amount of laundry of a washing machine, in which operating of a motor, regenerative braking of the motor, re-operating the motor and rheostatic braking of the motor are sequentially carried out, and the amount of the laundry is sensed by means of the principles of the conservation of energy in the regenerative and rheostatic braking of the motor, thereby precisely sensing the amount of the laundry without the influence of static friction.

In accordance with one aspect of the present invention, the above and other objects can be accomplished by the provision of a method for sensing an amount of laundry of a washing machine comprising the steps of: (a) operating a motor, and then carrying out regenerative braking of the motor; (b) re-operating the motor after the step (a), and then carrying out rheostatic braking of the motor; and (c) determining the amount of laundry by means of the principle of the conservation of energy in the regenerative braking of the motor in the step (a) and the principle of the conservation of energy in the rheostatic braking of the motor in the step (b).

In accordance with another aspect of the present invention, there is provided a method for sensing an amount of laundry of a washing machine comprising the steps of: (a′) operating a motor, and then carrying out rheostatic braking of the motor; (b′) re-operating the motor after the step (a), and then carrying out regenerative braking of the motor; and (c′) determining the amount of laundry by means of the principle of the conservation of energy in the rheostatic braking of the motor in the step (a′) and the principle of the conservation of energy in the regenerative braking of the motor in the step (b′).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal-sectional view of a conventional washing machine;

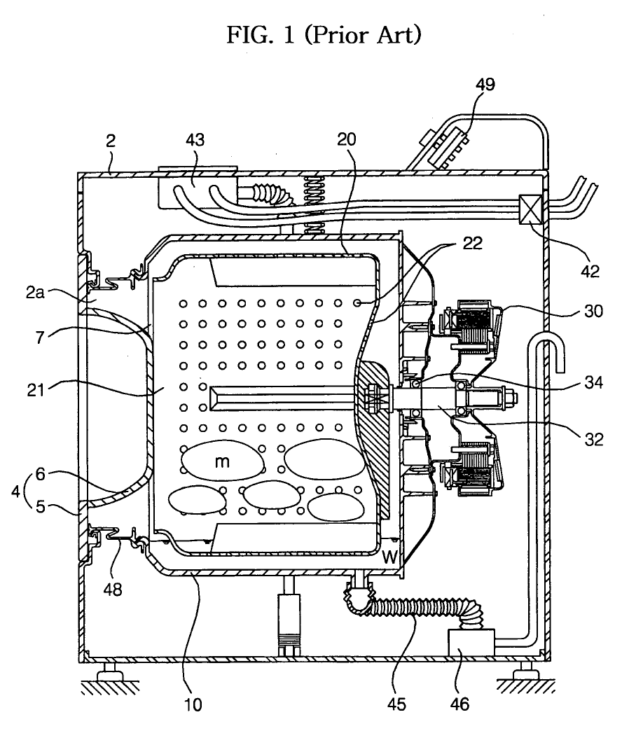

FIG. 2 is a block diagram of a braking device of the conventional washing machine;

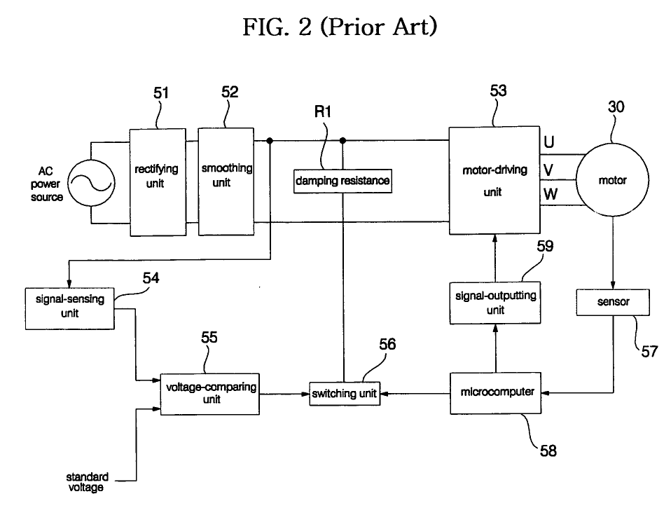

FIG. 3 is a flow chart illustrating a method for sensing an amount of laundry of the conventional washing machine;

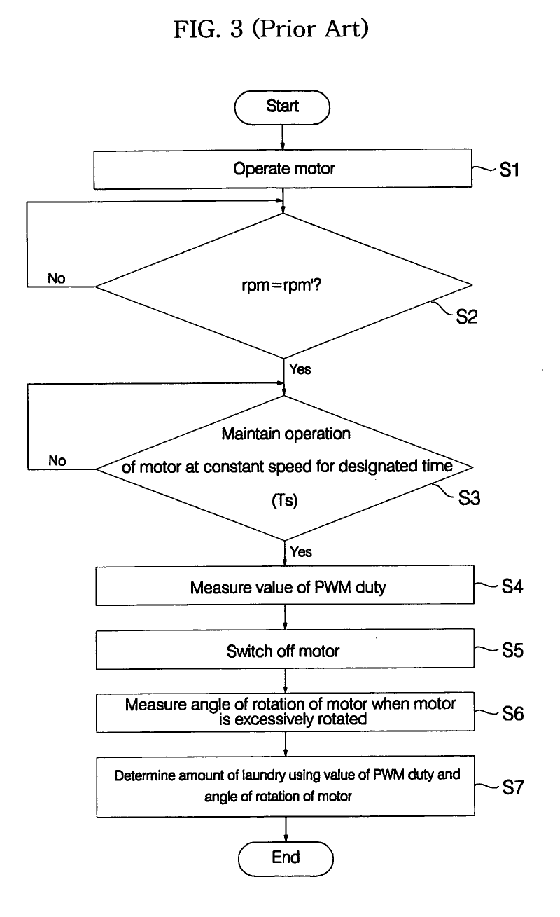

FIG. 4 is a graph illustrating operation of a motor for sensing the amount of laundry of the conventional washing machine;

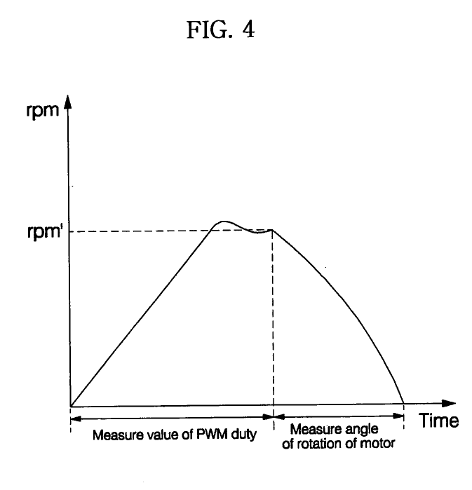

FIG. 5 is a flow chart illustrating a method for sensing an amount of laundry of a washing machine in accordance with one embodiment of the present invention;

FIG. 6 is a graph illustrating operation of a motor for sensing the amount of laundry of the washing machine in accordance with one embodiment of the present invention;

FIG. 7 is a flow chart illustrating a method for sensing an amount of laundry of a washing machine in accordance with another embodiment of the present invention; and

FIG. 8 is a graph illustrating operation of a motor for sensing the amount of laundry of the washing machine in accordance with another embodiment of the present invention.

### DESCRIPTION OF THE PREFERRED EMBODIMENTS

Now, preferred embodiments of the present invention will be described in detail with reference to the annexed drawings.

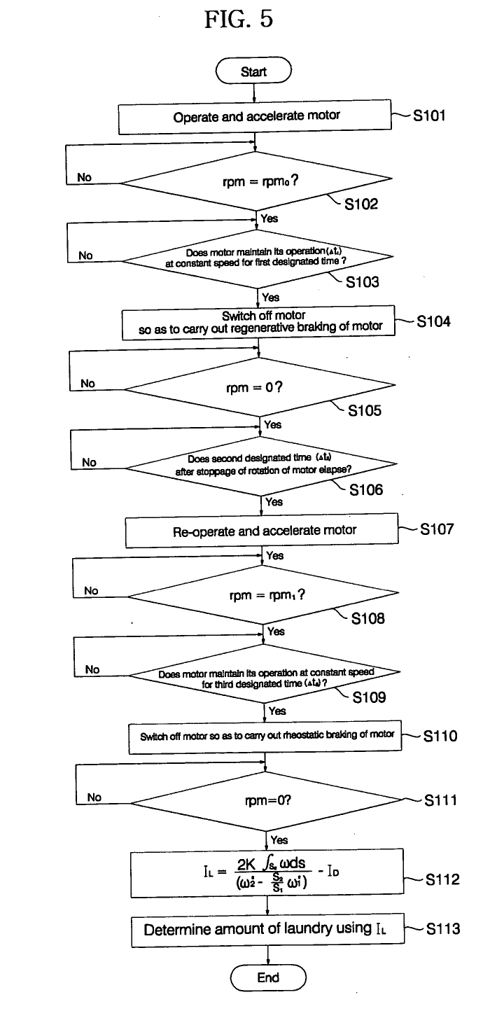

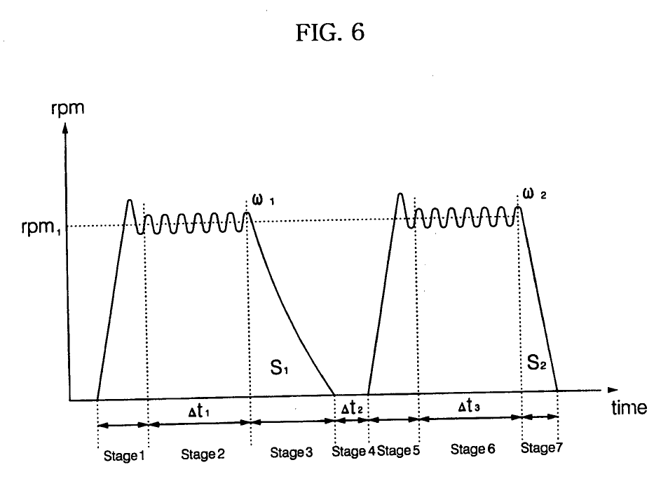

FIG. 5 is a flow chart illustrating a method for sensing an amount of laundry of a washing machine in accordance with one embodiment of the present invention. FIG. 6 is a graph illustrating operation of a motor for sensing the amount of laundry of the washing machine in accordance with one embodiment of the present invention.

Herein, components of the washing machine of this embodiment are substantially the same as those of the conventional washing machine and thus denoted by the same reference numerals even though they are depicted in different drawings. Further, a detailed description of the components will be omitted because it is considered to be unnecessary.

Now, the method for sensing an amount of laundry of a washing machine in accordance with one embodiment of the present invention will be described in detail with reference to FIGS. 5 and 6.

First, the control unit 49 operates the motor 30, and then accelerates the motor 30 until a rotational frequency (rpm) of the motor 30 reaches a standard rotational frequency (rpm₁, for example 130 rpm) (stage 1, S101).

Thereafter, when the rotational frequency (rpm) of the motor 30 reaches the standard rotational frequency (rpm₁), the control unit 49 constantly maintains the operation of the motor 30 at the standard rotational frequency (rpm₁) for a first designated time (Δt₁) (stage 2, S102 and S103).

After the control unit 49 constantly maintains the operation of the motor 30 at the standard rotational frequency (rpm₁) for the first designated time (Δt₁), the control unit 49 switches off the motor (stage 3), and accumulates electricity regenerated by the excess rotation of the motor 30 (S104).

That is, the control unit 49 switches off a damping resistance (R) of the braking device 50, thereby allowing regenerative current to be accumulated in the smoothing unit 52.

When a second designated time (Δt₂) after the stoppage of the rotation of the motor 30 elapses (stage 4), the control unit 49 re-operates the motor 30 and then accelerates the motor 30 until a rotational frequency (rpm) of the motor 30 reaches the standard rotational frequency (rpm₁, for example 130 rpm) (stage 5, S105, S106 and S107).

Thereafter, when the rotational frequency (rpm) of the motor 30 reaches the standard rotational frequency (rpm₁), the control unit 49 constantly maintains the operation of the motor 30 at the standard rotational frequency (rpm₁) for a third designated time (Δt₃) (stage 6, S108 and S109).

After the control unit 49 constantly maintains the operation of the motor 30 at the standard rotational frequency (rpm₁) for the third designated time (Δt₃), the control unit 49 switches off the motor 30 (stage 7), and dissipates electricity regenerated by the excess rotation of the motor 30 in the form of heat (S110).

That is, the control unit 49 switches on the damping resistance (R) of the braking device 50, thereby preventing regenerative current from being accumulated in the smoothing unit 52.

In the method for sensing the amount of laundry of the washing machine in accordance with one embodiment of the present invention, a moment of inertia of the laundry is calculated using the principle of the conservation of energy in regenerative braking of the motor 30 and the principle of the conservation of energy in rheostatic braking of the motor 3, and the amount of laundry in the washing machine is determined by the calculated moment of inertia of the laundry.

That is, an energy equation in the regenerative braking is

$$\frac{1}{2} ( {I}_{D} + {I}_{L} ) {w}_{1}^{2} = {T}_{f} {s}_{1} ,$$

and an energy equation in the rheostatic braking is

$$\frac{1}{2} ( {I}_{D} + {I}_{L} ) {w}_{1}^{2} = {\int }_{{S}_{2}} k \cdot w ⅆ s + {T }_{f} {s}_{2} .$$

Based on the above energy equations, a first equation regarding the moment of inertia of the laundry is obtained, as follows.

$${I}_{L} = \frac{2 k {\int }_{{S}_{2}} w ⅆ s}{( {w}_{2}^{2} - \frac{{s}_{2}}{{s}_{1}} {w}_{1}^{2} )} - {I}_{D} \qquad [ First equation ]$$

Here, I_{L} denotes moment of inertia of the laundry, I_{D} denotes moment of inertia of the drum, determined by tests, w₁ denotes an angular velocity of the drum when the regenerative braking of the motor is started, T denotes torque due to the friction defined to be a certain value, s₁ denotes an angle of rotation of the drum when the regenerative braking of the motor is carried out, s₂ denotes an angle of rotation of the drum when the rheostatic braking of the motor is carried out, k denotes a proportional constant of braking energy, when rheostatic braking of the motor is carried out, determined by tests, w denotes an angular velocity of the motor when the rheostatic braking of the motor is carried out, s denotes an angle of rotation of the motor when the rheostatic braking of the motor is carried out, w₂ denotes an angular velocity of the drum when the rheostatic braking of the motor is started, and ∫ₛ_{₂}k·wds denotes braking energy when the rheostatic braking of the motor is carried out.

That is, in the method for sensing the amount of laundry of the washing machine in accordance with one embodiment: of the present invention, the angular velocity (w₁) of the drum when the regenerative braking of the motor 30 is started, the angular velocity (w₂) of the drum when the rheostatic braking of the motor 30 is started, the angle (s₁) of rotation of the drum when the regenerative braking of the motor 30 is carried out, and the angle (s₂) of rotation of the drum when, the rheostatic braking of the motor 30 is carried out are measured when the regenerative braking and rheostatic braking of the motor 30 are carried out. Thus, the moment (I_{L}) of inertia of the laundry is calculated from the above first equation by means of the above measured values.

Here, the angular velocities (w₁ and w₂) of the drum and the angles (s₁ and s₂) of rotation of the drum can be measured and outputted by a hall sensor separably installed on the motor 30 or by an encoder of the motor 30.

The angular velocity (w₁) of the drum, when the regenerative braking of the motor 30 is started, is measured when the regenerative braking of the motor 30 is started, and is then stored in the control unit 49. The angle (s₁) of rotation of the drum, when the regenerative braking of the motor 30 is carried out, is measured when the regenerative braking of the motor 30 is terminated, and is then stored in the control unit 49.

The angular velocity (w₂) of the drum, when the rheostatic braking of the motor 30 is started, is measured when the rheostatic braking of the motor 30 is started, and is then stored in the control unit 49. The angle (s₂) of rotation of the drum, when the rheostatic braking of the motor 30 is carried out, is measured when the rheostatic braking of the motor 30 is terminated, and is then stored in the control unit 49.

After the rheostatic braking of the motor 30 is terminated, the control unit 49 applies the angular velocity (w₁) of the drum when the regenerative braking of the motor 30 is started, the angular velocity (w₂) of the drum when the rheostatic braking of the motor 30 is started, the angle (s₁) of rotation of the drum when the regenerative braking of the motor 30 is carried out, and the angle (s₂) of rotation of the drum when the rheostatic braking of the motor 30 is parried out, to the above first equation, thereby calculating the moment (I_{L}) of inertia of the laundry (S111 and S112).

Thereafter, the control unit 49 finally determines an amount of the laundry using the calculated moment (I_{L}) Of inertia of the laundry based on a table or proportional expression, which is set in advance (S113).

That is, the moment (I_{L}) of inertia of the laundry rotating in the washing machine corresponds to a quantity of the laundry, thus being used as an index of the amount of the laundry.

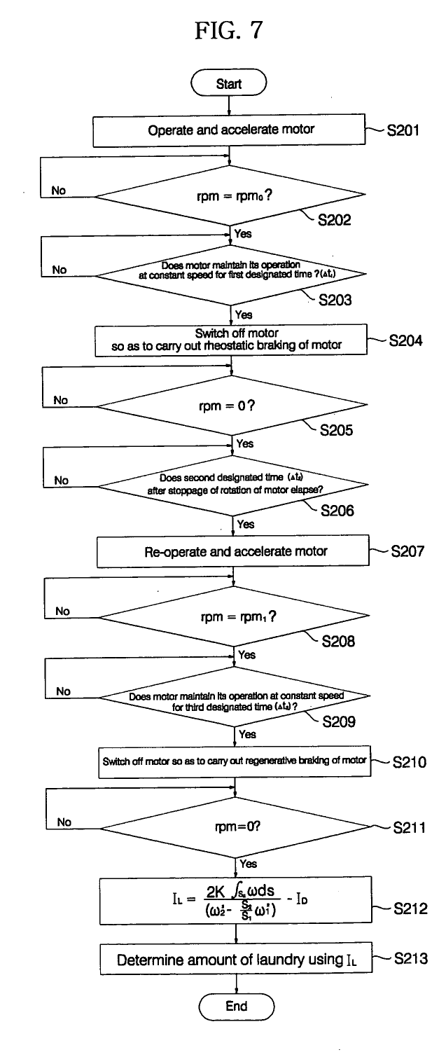

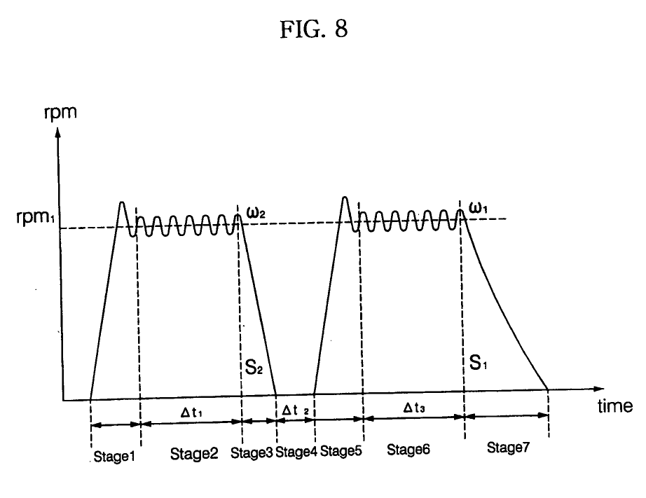

FIG. 7 is a flow chart illustrating a method for sensing an amount of laundry of a washing machine in accordance with another embodiment of the present invention. FIG. 8 is a graph illustrating operation of a motor for sensing the amount of laundry of the washing machine in accordance with another embodiment of the present invention.

Now, the method for sensing an amount of laundry of a washing machine in accordance with another embodiment of the present invention will be described in detail with reference to FIGS. 7 and 8.

First, the control unit 49 operates the motor 30, and then accelerates the motor 30 until a rotational frequency (rpm) of the motor 30 reaches a standard rotational frequency (rpm₁, for example 130 rpm) (stage 1, S201).

Thereafter, when the rotational frequency (rpm) of the motor 30 reaches the standard rotational frequency (rpm₁), the control unit 49 constantly maintains the operation of the motor 30 at the standard rotational frequency (rpm₁) for a first designated time (Δt₁) (stage 2, S202 and S203).

After the control unit 49 constantly maintains the operation of the motor 30 at the standard rotational frequency (rpm₁) for the first designated time (Δt₁), the control unit 49 switches off the motor (stage 3), and dissipates electricity, regenerated by the excess rotation of the motor 30, in the form of heat (S204).

That is, the control unit 49 switches on the damping resistance (R) of the braking device 50, thereby preventing regenerative current from being accumulated in the smoothing unit 52.

When a second designated time (Δt₂) after the stoppage of the rotation of the motor 30 elapses (stage 4), the control unit 49 re-operates the motor 30 and then accelerates the motor 30 until a rotational frequency (rpm) of the motor 30 reaches the standard rotational frequency (rpm₁, for example 130 rpm) (stage 5, S205, S206 and S207).

Thereafter, when the rotational frequency (rpm) of the motor 30 reaches the standard rotational frequency (rpm₁), the control unit 49 constantly maintains the operation of the motor 30 at the standard rotational frequency (rpm₁) for a third designated time (Δt₃) (stage 6, S208 and S209).

After the control unit 49 maintains the operation of the motor 30 at the standard rotational frequency (rpm₁) for the third designated time (Δt₃), the control unit 49 switches off the motor 30 (stage 7), and accumulates electricity regenerated by the excess rotation of the motor 30 (S210).

That is, the control unit 49 switches off the damping resistance (R) of the braking device 50, thereby allowing regenerative current to be accumulated in the smoothing unit 52.

In the method for sensing the amount of laundry of the washing machine in accordance with this embodiment of the present invention, a moment (I_{L}) of inertia of the laundry is calculated using the principle of the conservation of energy in rheostatic braking of the motor 30 and the principle of the conservation of energy in regenerative braking of the motor 3, and the amount of laundry in the washing machine is determined by the calculated moment (I_{L}) of inertia of the laundry.

The same as the first embodiment of the present invention, the calculated moment (I_{L}) of inertia of the laundry in the second embodiment of the present invention is calculated by the above first equation. After the rheostatic braking of the motor 30 is terminated, the control unit 49 applies the angular velocity (w₂) of the drum when the rheostatic braking of the motor 30 is started, the angular velocity (w₁) of the drum when the regenerative braking of the motor 30 is started, the angle (s₂) of rotation of the drum when the rheostatic braking of the motor 30 is carried out, and the angle (s₁) of rotation of the drum when the regenerative braking of the motor 30 is carried out, to the above first equation, thereby calculating the moment (I_{L}) of inertia of the laundry (S211 and S212).

Thereafter, the control unit 49 finally determines an amount of the laundry using the calculated moment (I_{L}) Of inertia of the laundry based on a table or proportional expression, which is set in advance (S213).

As apparent from the above description, the method for sensing an amount of laundry of a washing machine in accordance with the present invention has advantages, as follows.

First, since the moment of inertia of the laundry is calculated by means of the principle of the conservation of energy in regenerative braking of a motor and the principle of the conservation of energy in rheostatic braking of the motor, and the amount of the laundry is determined by the calculated moment of inertia of the laundry, static friction generated when the motor is started does not influence the sensing of the amount of the laundry, and data obtained by braking the motor twice are used. Accordingly, it is possible to precisely sense the amount of the laundry.

Second, since the moment of inertia of the laundry is calculated by measuring an angular velocity of a drum when the regenerative braking of the motor is started, an angular velocity of the drum when the rheostatic braking of the motor is started, an angle of rotation of the drum when the regenerative braking of the motor is carried out, and an angle of rotation of the drum when the rheostatic braking of the motor is carried out, it is possible to remove the influence of errors, generated when frictional torque is measured, on the sensing of the amount of the laundry, to simplify the structure of a control unit for measuring the various values, and to minimize errors generated in sensing the amount of the laundry.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for sensing an amount of laundry of a washing machine comprising the steps of:
(a) operating a motor, and then carrying out regenerative braking of the motor;
(b) re-operating the motor after the step (a), and then carrying out rheostatic braking of the motor; and
(c) determining the amount of laundry by means of the principle of the conservation of energy in the regenerative braking of the motor in the step (a) and the principle of the conservation of energy in the rheostatic braking of the motor in the step (b).

2. The method as set forth in claim 1, wherein the step (a) includes the sub-steps of:
(a-1) accelerating the motor so that a rotational frequency of the motor reaches a standard rotational frequency;
(a-2) constantly maintaining the operation of the motor at the standard rotational frequency when the rotational frequency of the motor reaches the standard rotational frequency by the acceleration of the motor; and
(a-3) decelerating the motor by switching off the motor, after the maintenance of the operation of the motor, so that the regenerative braking of the motor is carried out.

3. The method as set forth in claim 2,
wherein the sub-step (a-2) is a sub-step of constantly maintaining the operation of the motor at the standard rotational frequency for a designated time.

4. The method as set forth in claim 1,
wherein the step (b) is carried out when a designated time after the termination of the step (a) elapses.

5. The method as set forth in claim 1,
wherein the step (b) includes the sub-steps of:
(b-1) accelerating the motor so that a rotational frequency of the motor reaches a standard rotational frequency;
(b-2) constantly maintaining the operation of the motor at the standard rotational frequency when the rotational frequency of the motor reaches the standard rotational frequency by the acceleration of the motor; and
(b-3) decelerating the motor by switching off the motor, after the maintenance of the operation of the motor, so that the rheostatic braking of the motor is carried out.

6. The method as set forth in claim 5,
wherein the sub-step (b-2) is a sub-step of constantly maintaining the operation of the motor at the standard rotational frequency for a designated time.

7. The method as set forth in claim 1,
wherein the step (c) includes the sub-steps of:
(c-1) storing angular velocities of a drum and angles of rotation of the drum when the regenerative braking and rheostatic braking of the motor are started in the steps (a) and (b);
(c-2) applying the stored angular velocities and angles of rotation of the drum to an equation regarding moment of inertia of the laundry using the principle of the conservation of energy in the regenerative braking of the motor in the step (a) and the principle of the conservation of energy in the rheostatic braking of the motor in the step (b), and thereby calculating the moment of inertia of the laundry; and
(c-3) determining the amount of laundry based on the calculated moment of inertia of the laundry in the step (c-2).

8. The method as set forth in claim 7,
wherein the angular velocities and angles of rotation of the drum are outputted from an encoder of the motor.

9. The method as set forth in claim 7,
wherein the angular velocities and angles of rotation of the drum are outputted from a hall sensor installed on the motor.

10. The method as set forth in claim 7, wherein the equation is defined by
$${I}_{L} = \frac{2 k {\int }_{{S}_{2}} w ⅆ s}{( {w}_{2}^{2} - \frac{{s}_{2}}{{s}_{1}} {w}_{1}^{2} )} - {I}_{D} ,$$
wherein I_{L} denotes the moment of inertia of the laundry, k denotes a proportional constant of braking energy, when the rheostatic braking of the motor is carried out, determined by tests, w denotes an angular velocity of the motor when the rheostatic braking of the motor is carried out, s denotes an angle of rotation of the motor when the rheostatic braking of the motor is carried out, w₂ denotes an angular velocity of the drum when the rheostatic braking of the motor is started, s₂ denotes an angle of rotation of the drum when the rheostatic braking of the motor is carried out, s₁ denotes an angle of rotation of the drum when the regenerative braking of the motor is carried out, w₁ denotes an angular velocity of the drum when the regenerative braking of the motor is started, and I_{D} denotes a moment of inertia of the drum, determined by tests.

11. A method for sensing an amount of laundry of a washing machine comprising the steps of:
(a′) operating a motor, and then carrying out rheostatic braking of the motor;
(b′) re-operating the motor after the step (a), and then carrying out regenerative braking of the motor; and
(c′) determining the amount of laundry by means of the principle of the conservation of energy in the rheostatic braking of the motor in the step (a′) and the principle of the conservation of energy in the regenerative braking of the motor in the step (b′).

12. The method as set forth in claim 11, wherein the step (a′) includes the sub-steps of:
(a′-1) accelerating the motor so that a rotational frequency of the motor reaches a standard rotational frequency;
(a′-2) constantly maintaining the operation of the motor at the standard rotational frequency when the rotational frequency of the motor reaches the standard rotational frequency by the acceleration of the motor; and
(a′-3) decelerating the motor by switching off the motor, after the maintenance of the operation of the motor, so that the rheostatic braking of the motor is carried out.

13. The method as set forth in claim 12,
wherein the sub-step (a′-2) is a sub-step of constantly maintaining the operation of the motor at the standard rotational frequency for a designated time.

14. The method as set forth in claim 11,
wherein the step (b′) is carried out when a designated time after the termination of the step (a′) elapses.

15. The method as set forth in claim 11,
wherein the step (b′) includes the sub-steps of:
(b′-1) accelerating the motor so that a rotational frequency of the motor reaches a standard rotational frequency;
(b′-2) constantly maintaining the operation of the motor at the standard rotational frequency when the rotational frequency of the motor reaches the standard rotational frequency by the acceleration of the motor; and
(b′-3) decelerating the motor by switching off the motor, after the maintenance of the operation of the motor, so that the regenerative braking of the motor is carried out.

16. The method as set forth in claim 15,
wherein the sub-step (b′-2) is a sub-step of constantly maintaining the operation of the motor at the standard rotational frequency for a designated time.

17. The method as set forth in claim 11,
wherein the step (c′) includes the sub-steps of:
(c′-1) storing angular velocities of a drum and angles of rotation of the drum when the rheostatic braking and regenerative braking of the motor are started in the steps (a′) and (b′);
(c′-2) applying the stored angular velocities and angles of rotation of the drum to an equation regarding moment of inertia of the laundry using the principle of the conservation of energy in the rheostatic braking of the motor in the step (a′) and the principle of the conservation of energy in the regenerative braking of the motor in the step (b′), and thereby calculating the moment of inertia of the laundry; and
(c′-3) determining the amount of laundry based on the calculated moment of inertia of the laundry in the step (c′-2).

18. The method as set forth in claim 17,
wherein the angular velocities and angles of rotation of the drum are outputted from an encoder of the motor.

19. The method as set forth in claim 17,
wherein the angular velocities and angles of rotation of the drum are outputted from a hall sensor installed on the motor.

20. The method as set forth in claim 17, wherein the equation is defined by
$${I}_{L} = \frac{2 k {\int }_{{S}_{2}} w ⅆ s}{( {w}_{2}^{2} - \frac{{s}_{2}}{{s}_{1}} {w}_{1}^{2} )} - {I}_{D} ,$$
wherein I_{L} denotes the moment of inertia of the laundry, k denotes a proportional constant of braking energy, when the rheostatic braking of the motor is carried out, determined by tests, w denotes an angular velocity of the motor when the rheostatic braking of the motor is carried out, s denotes an angle of rotation of the motor when the rheostatic braking of the motor is carried out, w₂ denotes an angular velocity of the drum when the rheostatic braking of the motor is started, s₂ denotes an angle of rotation of the drum when the rheostatic braking of the motor is carried out, s₁ denotes an angle of rotation of the drum when the regenerative braking of the motor is carried out, w₁ denotes an angular velocity of the drum when the regenerative braking of the motor is started, and I_{D} denotes moment of inertia of the drum, determined by tests.
